(19) United States
(12) Patent Application Publication
(10) Pub. No.: US 2026/0112551 A1
(43) Pub. Date: Apr. 23, 2026

(54) DISCONNECTOR CONTACT SYSTEM WITH CONTROLLED DISCHARGE

(71) Applicant: Hitachi Energy Ltd, Zürich (CH)

(72) Inventors: Markus M. Keller, Winterthur (CH); Diego Felipe Sologuren-Sanchez, Wettingen (CH); Ulrich Straumann, Winterthur (CH); David Saxl, Zürich (CH); Prashant Rajpal, VADODARA (IN)

(21) Appl. No.: 19/160,875

(22) PCT Filed: Mar. 28, 2024
(86) PCT No.: PCT/EP2024/058707

§ 371 Date: Aug. 29, 2025

(30) Foreign Application Priority Data
Mar. 30, 2023 (EP) 23165588.7

(51) Int. Cl. H01H 1/06; H01H 33/02; H01H 33/04; H01H 33/12; H01H 33/24

(52) U.S. Cl. CPC H01H 1/06; H01H 33/021; H01H 33/045; H01H 33/12; H01H 33/24

(57) ABSTRACT

Embodiments herein provide a disconnector (300) for an electrical apparatus (200), comprising a first contact (310) having a longitudinal center axis and a second contact (320). At least one of the first contact (310) and the second contact (320) is movable in a direction of the longitudinal center axis of the first contact (310), the first contact (310) being connected to the second contact (320) in a closed position and disconnected from the second contact (320) in an open position. The first contact (310), at an end thereof directed towards and adjacent to the second contact (320), has a contact tip (330) comprising an ignition tip (335) at an inner opening of the first contact (310) defined by the contact tip (330), and where the ignition tip (335) protrudes from a neighbouring, surrounding part of the contact tip (330) in the direction of the longitudinal center axis.

### CROSS REFERENCE TO RELATED APPLICATIONS

This application is a 35 U.S.C. § 371 national stage application of PCT International Application No. PCT/EP2024/058707 filed on Mar. 28, 2024, which in turn claims priority to European Patent Application No. 23165588.7, filed on Mar. 30, 2023, the disclosures and content of which are incorporated by reference herein in their entireties.

### TECHNICAL FIELD

The present disclosure generally relates to a gas-insulated high voltage device. More particularly, it relates to a contact system of a switching device with controlled discharge root point.

### BACKGROUND

A switching apparatus is used for isolating electrical devices from a power line or to disconnect a section of power line from another. The switching apparatus includes a disconnector switch, DS, (for example, a vertical break disconnector) and/or an earthing switch. The DS is a mechanical switch adapted for connecting or disconnecting the electrical devices from the power line. The DS is typically used in high voltage environment to form a visible disconnecting point to ensure a reliable isolation of the electrical devices from the power line, such that the electrical devices can be operated or maintained safely without a load. FIGS. 1 and 2 that are adapted from a published Cigré technical Brochure are described herein. A DS 100, as depicted in FIG. 1, has a contact system comprising two contacts, a moving contact 110 and a fixed contact 120 placed in a closed chamber. In normal conditions, the two contacts 110 and 120 remain connected (i.e., a closed position). When the DS is required to disconnect a part of the switchgear, the two contacts 110 and 120 separate (i.e., an open position) to interrupt an electrical circuit.

Generally, with the disconnector 100 under service voltage applications, during switching operations (for example, bus-charging switching currents), the moving contact 110 is switched between the closed position and the open position. Due to the action of the moving contact 110, a spark or capacitive discharges (i.e., pre-strike or restrike discharges) may be formed between the two contacts 110 and 120 in a case of bus-charging current switching.

For example, during closing, the spark may be formed before the moving contact 110 has reached/touched the fixed contact 120. During opening, the spark may be formed before the moving contact 110 has reached the fully open position. Further, a current continues to flow between the two contacts 110 and 120 through the spark. The closed compartment in which the two contacts 110 and 120 have been placed may contain a fluid insulating medium (either liquid or gas), which quenches/extinguishes the spark formed between the two contacts 110 and 120.

Further, under certain conditions, the formed discharges/spark may cause disruptive discharges from the contact system of the disconnector to the enclosure (i.e., ground potential), which leads to an internal spark and failure of the DS. For example, the discharges/spark (i.e., pre-strike or restrike discharges) formed between the contacts 110 and 120 of a partially closed contact system is depicted in FIG. 1, wherein the moving contact 110 is fixed at a certain position under multiple voltage applications.

With existing designs of the contact system of the disconnector 100 as described above, the discharges/spark may often start at locations of or near a front edge (tip) of the moving contact 110, wherein locations of the moving contact 110 may close to or even on an outer tube surface of the moving contact 110. Thus, such discharges may have a higher probability of leading to disruptive spark/discharges to the enclosure than discharges/spark starting closer to an inner tube surface of the moving contact 110.

In addition, the spark/discharges formed between the contacts 110 and 120 may get in contact with the closed chamber or any other element of the DS that may be at the enclosure/ground potential, thereby damaging elements of the disconnector 100/CB. For example, how the spark propagates and establishes the contact with the closed chamber or any other element of the DS that may be at the enclosure/ground potential is depicted in the FIGS. 2A, 2B, 2C, and 2D.

### SUMMARY

With existing designs of the disconnector of the DS, the spark may start at a location of or near a front edge of the moving contact edge, which is close to or even on an outer surface of the moving contact. Such a spark has a higher probability of getting in contact with the closed chamber of the DS or any other element of the DS that is at the ground potential as compared to a spark that may start closer to an inner surface or to a longitudinal center axis of the moving contact.

The likelihood of such undesired acentric discharges is larger in the instance where the moving contact is stressed with positive potential during the bus-charging current switching duty. In this configuration, due to lacking a first-electron to initiate the discharge, the discharge root points may spread wider on the moving contact. Due to statistical reasons, the discharge may occur at undesired acentric locations.

In most cases, any of the two contacts of the disconnector are not specially designed and therefore the spark may start from an undesirable point on the moving contact. Therefore, it is difficult to limit the spark to remain at an axial center of the disconnector and further it is difficult to avoid the contact of the spark with the chamber or any other element of the DS that may be at the ground potential.

The problem of the lack of the first-electron to initiate the discharge on the positively stressed moving contact may be overcome by providing the first electron from the negatively stressed fixed contact-side by field emission.

Consequently, there is a need for a disconnector with at least one of two contacts designed in such a way that a spark is limited to remain at an axial center of the disconnector, thereby avoiding a contact of the spark with a closed chamber or any other element of a DS that may be at a ground potential.

It is therefore an object of the present disclosure to provide a disconnector for an electrical apparatus, to mitigate, alleviate, or eliminate all or at least some of the above-discussed drawbacks of presently known solutions.

This and other objects are achieved by means of a disconnector as defined in the appended claims. The term exemplary is in the present context to be understood as serving as an instance, example or illustration.

According to an aspect of the present disclosure, a disconnector for an electrical apparatus is provided. The disconnector comprises a first contact having a longitudinal center axis and a second contact, wherein at least one of the first contact and the second contact is movable in a direction of the longitudinal center axis of the first contact, wherein the first contact is connected to the second contact in a closed position, wherein the first contact is disconnected from the second contact in an open position, wherein the first contact, at an end thereof directed towards and adjacent to the second contact, has a contact tip comprising an ignition tip provided at an inner opening of the first contact defined by the contact tip, and wherein the ignition tip protrudes from a neighbouring, surrounding part of the contact tip in the direction of the longitudinal center axis.

For a field emission to happen requires appropriate roughness on either the first contact or the second contact. Ions generated by the field emission may drift along field lines to the other contact, where they may detach an electron and initiate the spark/discharge.

Advantageously, with the proposed disconnector, the discharges/spark formed between the two contacts may occur closer to the longitudinal center axis of the first contact. As a result, shielding effect of fixed electrodes at the first contact and the second contact on a discharge channel may be maximized.

Further, with the proposed disconnector, a risk of disruptive discharges (i.e., pre-strikes or restrikes formed between the two contacts) to enclosure (i.e., ground potential) may be reduced during switching of bus-charging current switching. The risk of disruptive discharges may be reduced by centring a path of the discharges/spark closer to the longitudinal center axis of the first contact.

According to some embodiments, the first contact is tubular.

In some embodiments, the ignition tip is located between an inner periphery of said end and

$$Ri + \frac{1}{3} ( Ro - Ri ) ,$$

wherein Ro is the outer radius of the contact tip at said end and Ri is the inner radius of the contact tip at said end.

In some embodiments, an angle (0) formed by any two inner radii constituting the ignition tip is at least 90 degrees.

In some embodiments, a position of the ignition tip in an axial direction is equal to a crest of a contour of the first contact.

In some embodiments, the position of the ignition tip in the axial direction is not less than a crest of a contour of the first contact by an average radius of the ignition tip.

In some embodiments, in the open position and upon application of a voltage difference between the first contact and the second contact, the ignition tip has a higher field gradient compared to remaining portions of the contact tip.

In some embodiments, in the open position and upon application of a voltage difference between the first contact and the second contact, the field gradient at the ignition tip is at least 20% higher as compared to remaining portions of the contact tip.

In some embodiments, in the open position and upon application of a voltage difference between the first contact and the second contact, the field gradient at the ignition tip is 30% to 70% higher as compared to remaining portions of the contact tip.

In some embodiments, the disconnector comprises a spindle extending through the first contact and having a longitudinal center axis which coincides with the longitudinal center axis of the first contact, and wherein the contact tip defines an opening provided for the protrusion of the spindle in connection to a motion of the spindle in relation to the first contact in the direction of the longitudinal center axis of the first contact.

In some embodiments, the second contact presents a recess in which the ignition tip is received without being in physical contact with the second contact in the closed position of the disconnector.

In some embodiments, the contact tip of the first contact is rotationally symmetric, and wherein a diameter of the rotation is at least larger than an average radius of the ignition tip.

In some embodiments, the first contact is movably arranged in a direction of the longitudinal center axis, wherein the second contact is a fixed contact and wherein in said closed position, the contact tip is connected to the second contact.

In some embodiments, a thickness of a wall of the first contact is at least larger than the average radius of the ignition tip if the first contact is rotationally symmetric, and the average radius of the ignition tip is at least smaller than an average radius of the surrounding part of the contact tip.

In some embodiments, the average radius of the ignition tip is at least a threshold times smaller than the average radius of the surrounding part of the contact tip, wherein the threshold is 5+5 times a surface ratio, and wherein the surface ratio is the ratio of rest of the first contact to the ignition tip.

In some embodiments, the disconnector comprises an insulating medium between the first contact (310) and the second contact (320), wherein the insulating medium comprises at least one of Sulphur hexafluoride, SF₆, air, Carbon dioxide, CO₂, Oxygen, O₂, a fluoroketone mixture, and a nitrile mixture.

Advantageously, with the proposed arrangement of the first contact and the second contact and a special design of an electrode geometry of the first contact, the discharges/spark may be generated from the pre-determined contact portion. Thereby, centralizing a path of the discharges/spark by shifting it closer to the longitudinal center axis of the first contact.

Other advantages may be readily apparent to one having skill in the art. Certain embodiments may have some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses a schematic diagram of an example disconnector according to the prior art (adapted from Cigré Brochure 260);

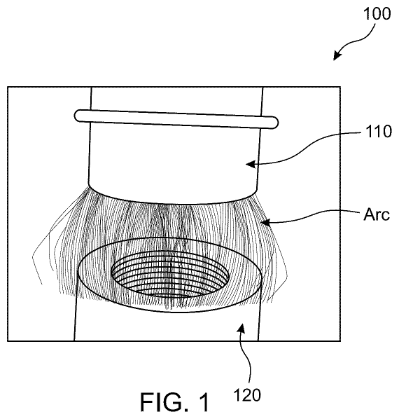

FIGS. 2A, 2B, 2C, and 2D discloses an example path followed by a spark to establish contact with a closed chamber or any other elements of a disconnector switch, DS, that are at enclosure/ground potential according to the prior art (adapted from Cigré Brochure 260);

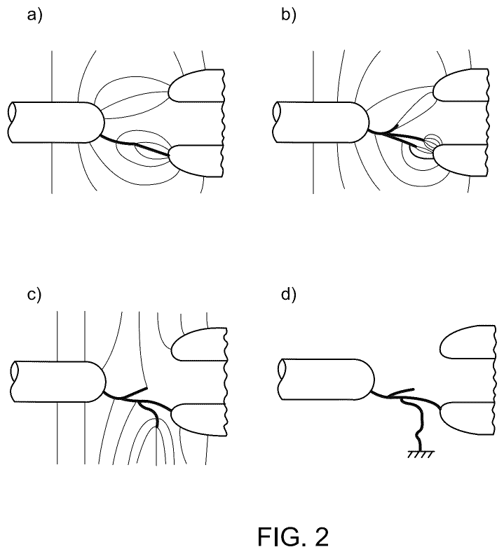

FIG. 3 discloses a schematic diagram illustrating an example disconnector according to some embodiments;

FIG. 4 discloses a schematic diagram illustrating an example moving contact according to some embodiments;

FIG. 5 discloses a schematic diagram illustrating an example of radii of the moving contact;

FIG. 6 discloses a schematic diagram illustrating an example of ignition tip of the moving contact; and

FIG. 7 discloses a schematic diagram illustrating an example fixed contact according to some embodiments.

### DETAILED DESCRIPTION

Aspects of the present disclosure will be described more fully hereinafter with reference to the accompanying drawings. The disconnector disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

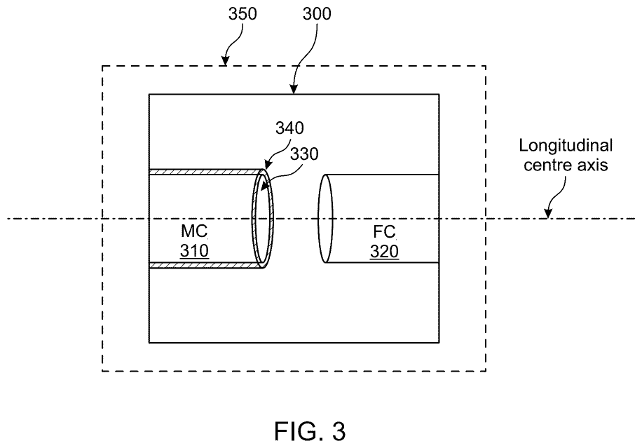

FIG. 3 discloses a schematic diagram of an example disconnector 300 for an electrical apparatus 350. The electrical apparatus 350 may be a disconnector switch, DS. The DS may be a switching device capable of making, conducting, and breaking current in an electrical circuit in normal conditions. The DS may also be configured for making, conducting for a specified period, and automatically breaking current in the electrical circuit under specified abnormal conditions. In an example, the specified abnormal conditions may be a short-circuit fault.

The disconnector 300 referred herein may be adapted for an electrical apparatus 350. The disconnector 300 may be a Gas Insulated Switchgear, GIS, disconnector or a mixed technology switchgear, MTS, which is a combination of components of air insulated switchgear, AIS, or a combination of the AIS and the GIS disconnector. The disconnector 300 comprises a contact system with at least two contacts, a first contact 310 and a second contact 320. At least one of the two contacts, i.e., the first contact 310 or the second contact 320 may be of a tubular shape, tubular shape being long, round, and hollow, like a tube. In an example, as depicted in FIG. 3, the first contact 310 is of the tubular shape. The at least one of the two contacts, whichever is configured to move is a moving contact, MC, for example, the first contact 310 and the other one of the two contacts may be a fixed contact, FC, for example, the second contact 320. Thus, in some embodiments described herein, the terms first contact, moving contact, and MC are used interchangeably. Similarly, the terms second contact and FC are used interchangeably.

The two contacts 310 and 320 are conductors of electricity and may be at an electrical potential while the DS is in operation. The first contact 310 and the second contact 320 may be placed in a closed chamber. The closed chamber may contain a fluid insulating medium (either liquid or gas).

During switching operations (for example, bus-charging switching currents), the first contact 310 is switched between the closed position and the open position. Due to the switching of the first contact 310, a spark or discharges (i.e., pre-strikes or restrike discharges) may be formed between the first contact 310 and the second contact 320. The fluid insulating medium in the closed chamber quenches/extinguishes the spark. The insulating medium in the DS in which circuit interruption is performed may be one or more of, but is not limited to, oil, air-break, air-blast, sulphur hexafluoride (SF₆), eco gases (air, CO₂, O₂, etc.), vacuum, a fluoroketone mixture, a nitrile mixture, and so on.

More specifically, among the two contacts, when the first contact 310 starts moving/separating from the second contact 320, the insulating medium between the two contacts 310 and 320 experiences a significantly high electric stress. The electric stress may be approximately inversely proportional to a distance between the first and second contacts 310 and 320. At an instant of the separation of the first and second contacts 310 and 320, the insulating medium between the first and second contacts 310 and 320 may breakdown because of the high electric stress. The breakdown of the insulating medium may result in formation of a conducting channel or the spark between the first and second contacts 310 and 320. With the movement of the first contact 310 further away from the second contact 320, the spark is drawn along with the movement of the first contact 310. The current continues to flow between the first and second contacts 310 and 320 through the spark, and therefore the interruption of the current is not effective. The interruption of the current may be considered effective only when the spark is finally quenched/extinguished and thereby ceases to exist.

In most cases, the first and second contacts 310 and 320 of the disconnector 300 are not specially designed and therefore the spark may start from any point on the first contact 310, i.e., from an undesirable point on the first contact 310. Such a spark/discharge may have a higher probability of leading to disruptive spark to an enclosure (i.e., ground potential). Further, it may be difficult to limit the spark to remain at a center, i.e., near a longitudinal center axis of the first contact 310. Accordingly, it may be difficult to avoid the contact of the spark with other elements of the DS that may be at the ground potential/enclosure, thereby leading to an internal spark and failure of the DS. A longitudinal center axis is an imaginary line passing through a centroid of a cross-section along a long axis of any object.

Therefore, according to embodiments of the present disclosure, the disconnector 300 for the electrical apparatus 350, is provided, which is designed to centralize the spark towards the longitudinal center axis of the first contact 310.

As depicted in FIG. 3, the disconnector 300 comprises the first contact 310 and the second contact 320. The first contact 310 is of a tubular shape having a longitudinal center axis. The first contact 310 may be movably arranged in a direction of the longitudinal center axis and the second contact 320 may be a fixed contact. The first contact 310 is connected to the second contact 320 in a closed position. The first contact 310 is disconnected from the second contact 320 in an open position. The first contact 310 may have an end surface directed towards the second contact 320. The first contact 310 and the second contact 320 may be placed in the closed chamber. In some examples, the closed chamber may comprise an eco-friendly gas mixture as the insulating medium, such as air, CO₂, O₂, a fluoroketone mixture, a nitrile mixture, etc.

In some embodiments, the disconnector 300 comprises a dielectric shield 340 that encloses the first contact 310.

At least one of: the first contact 310 and the second contact 320 is movable in a direction along a longitudinal center axis of the first contact 310. In an example, the longitudinal center axis of the first contact 310 is same as a longitudinal center axis of the disconnector 300. A longitudinal center axis is an imaginary line passing through a centroid of a cross-section along a long axis of any object.

Further, at least one of the pair of the first and second contacts 310 and 320 of the disconnector 300 comprises a contact tip 330 at one of its ends, the end that is directed towards and adjacent to the other contact of the pair. In an example, the first contact 310 is provided with the contact tip 330 at one end of the first contact, the end that is directed towards and adjacent to the second contact 320.

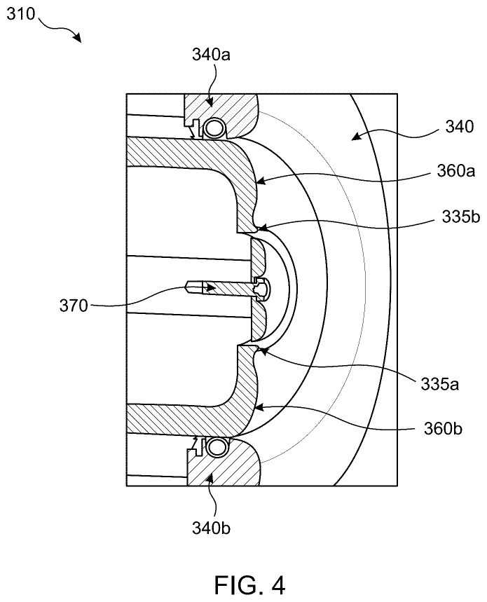

FIG. 4 discloses a schematic diagram of an example first contact 310 of the disconnector 300. In an example, the first contact 310 of the disconnector 300 comprises the contact tip 330 at one of its ends, the end that is directed towards and adjacent to the second contact 320 of the disconnector 300. The contact tip 330 comprises an ignition tip 335, 335a, 335b that is provided at an inner opening of the first contact 310 defined by the contact tip 330. The ignition tip 335 protrudes from a neighbouring, surrounding part of the contact tip in the direction of the longitudinal center axis. The ignition tip 335 is closer to the second contact 320 as compared to other remaining/neighbouring portion of the contact tip 330. The neighbouring portion may be the rest of the portions of the contact tip 330 other than the ignition tip 335. The ignition tip 335 may be located closer to the longitudinal center axis of the first contact 310 than are located said neighbouring portions. In an example, the ignition tip 335 is located between an inner periphery of said end and

$$Ri + \frac{1}{3} ( Ro - Ri ) ,$$

wherein Ro is the outer radius of the contact tip 330 at said end and Ri is the inner radius of the contact tip 330 at said end. The contact tip 330 is connected to the second contact 320 in the closed position. In an example, an angle formed by any two radii constituting the ignition tip 335 is at least 90 degrees.

In an example, the ignition tip 335 is located at a point in an axial direction, the point being geometrically equal to a crest of a contour 360, 360a, 360b of the first contact 310. In another example, the position of the ignition tip 335 at a point in the axial direction is not less than the crest of the contour 360 of the first contact 310 by an average radius of the ignition tip 335. In particular, the protrusion of the ignition tip in the axial direction is geometrically till the point, the point either being equal to the crest of the contour 360 or the point being geometrically not less than the crest of the contour 360 by the average radius of the ignition tip 335.

In the open position and upon application of a voltage difference between the first contact and the second contact, the ignition tip 335 has a higher field gradient compared to remaining portions of the contact tip 330. In some examples, in the open position and upon application of a voltage difference between the first contact 310 and the second contact 320, the field gradient at the ignition tip 335 is at least 20% higher as compared to remaining portions of the contact tip 330. In another example, in the open position and upon application of a voltage difference between the first contact and the second contact, the field gradient at the ignition tip 335 is 30% to 70% higher as compared to remaining portions of the contact tip 330.

Advantageously, by limiting the ignition tip 335 to a specific location that is nearer to the longitudinal center axis, a risk of acentric sparks/discharges at positive polarity is reduced.

The disconnector 300 comprises a spindle 370 extending through the first contact 310 and having a longitudinal center axis which coincides with the longitudinal center axis of the first contact 310. The contact tip 330 defines an opening provided for the protrusion of the spindle in connection to a motion of the spindle in relation to the first contact 310 in the direction of the longitudinal center axis of the first contact 310.

The disconnector 300 comprises the dielectric shield 340, 340a, 340b that encloses the first contact 310. The dielectric shield 340 extends to the region of the contact tip 330 and is in physical contact with the contact tip 330 in said region. The contact tip 330 of the first contact 310 is an end surface directed towards the second contact 320. The contact tip 330 partially closes an opening of the dielectric shield 340 such as to leave space between the dielectric shield 340 and the first contact 310, the space is enough for movement of the first contact 310 over the spindle 370. The dielectric shield 340 extends to an end region of the first contact 310 adjacent the second contact 320. Advantageously, the invention, by directing sparks to the center (inner periphery) of the first contact rather than to the outer periphery thereof, prevents degradation of the dielectric shield due to the sparks reaching the latter.

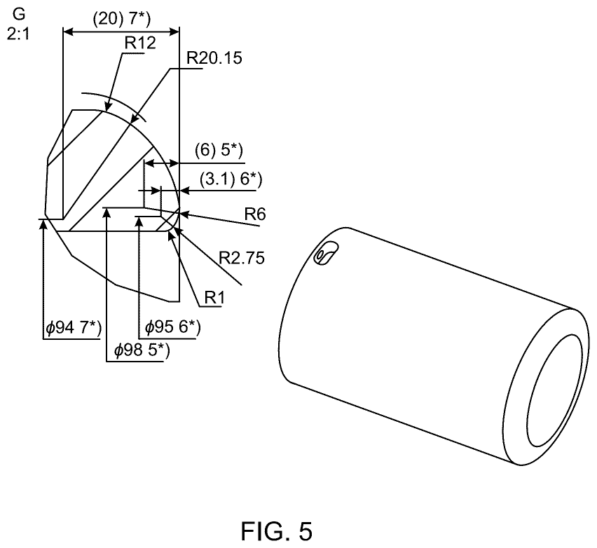

FIG. 5 discloses an alternate embodiment where a protrusion section of the ignition tip 335 is disclosed. The protrusion protrudes from the surrounding part i.e., edge circumference of the contact tip 330 in the direction of the longitudinal center axis. The protrusion section is defined by R1 and R6 as illustrated in FIG. 5.

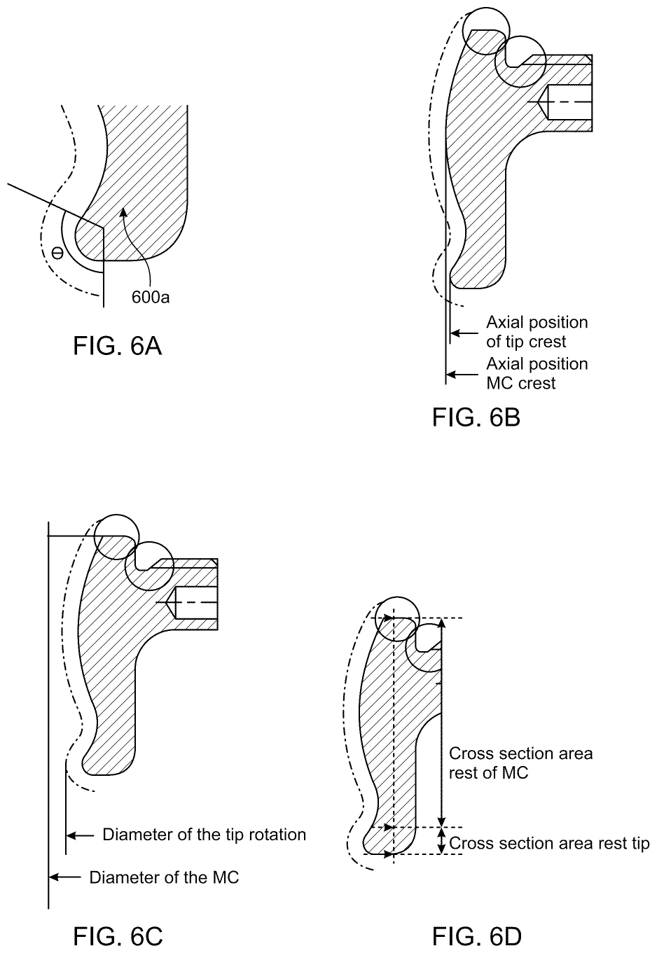

FIG. 6A discloses multiple radii rsi at different points on the ignition tip 335. The arithmetic average radius is rs. An angle formed by any two radii of the multiple radii constituting the ignition tip 335 is at least 90 degrees. FIG. 6B discloses a position of the ignition tip 335 in the axial direction, the position being equal to the crest of the contour 360 of the first contact 310. In another example, the position of the ignition tip 335 in the axial direction is not less than the crest of the contour 360 of the first contact 310 by an average radius of the ignition tip 335. In particular, a difference between the points of the location of the ignition tip 335 and the crest of the contour may at most be equal to the average radius. FIG. 6C discloses a diameter of a rotation of the first contact 310 according to an example where the first contact 310 is rotationally symmetric. The diameter of the rotation is larger than the average radius of the ignition tip 335. According to an example, the diameter of the rotation is at least 5 times larger than the average radius of the ignition tip 335. In an example, the average radius of the ignition tip 335 is smaller than an average radius of the surrounding part of the contact tip 330. In another example, the average radius of the ignition tip 335 is at least 5 times smaller than the average radius of the surrounding part of the contact tip 330. FIG. 6D discloses the average radius of the ignition tip 335 which is at least a threshold times smaller than the average radius of the surrounding part of the contact tip 330. In an example, the threshold is 5+5 times a surface ratio, wherein the surface ratio is the ratio of rest of the first contact 310 to the ignition tip 335.

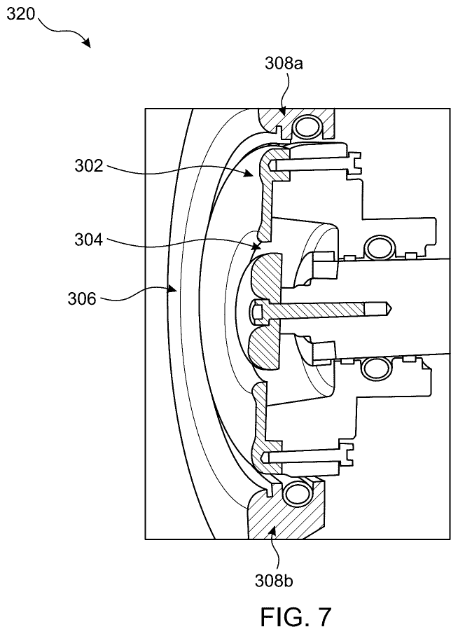

FIG. 7 discloses a schematic diagram of the second contact 320. A dielectric shield 308a, 308b encloses the second contact 320. The second contact 320 presents a recess 304 in which the ignition tip 335 is received without being in physical contact with the second contact 320 in the closed position of the disconnector 300. The second contact 320 is designed such that the second contact 320 avoids the physical contact with the ignition tip 335 in the closed position. The second contact 320 is designed to include the recess 304 and groove 302 at an end surface 306 of the second contact 320. The recess 304 is adapted to accommodate the ignition tip 335 in the closed position so as to avoid the physical contact between the ignition tip 335 and the second contact 320 in the closed position. The groove 302 is adapted to accommodate the remaining portions of the contact tip 330.

For the spark/discharge to establish, a first electron to start an electron avalanche is needed. The spark or the pre-strike and re-strike discharge, during the movement of the first contact 310 is initiated, from the ignition tip 335 which is near the inner surface of the first contact 310, as depicted in FIG. 4. Upon application of a voltage difference between the first contact 310 and the second contact 320 and in the open position, the ignition tip 335 has a higher field gradient compared to remaining portions of the contact tip 330, thereby provoking the discharge from the ignition tip 335.

Thus, by provoking the discharge to start at the ignition tip 335, which is close to the longitudinal center axis of the first contact 310, centring of the spark/discharge generated between the at least two contacts 310 and 320 towards the longitudinal center axis is achieved. Advantageously, a risk of spark spreading is minimized and thereby the risk of DS failure is eliminated.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1-14. (canceled)

15. A disconnector of an electrical apparatus, the disconnector comprises:
a first contact having a longitudinal center axis; and
a second contact, wherein at least one of the first contact and the second contact is movable in a direction of the longitudinal center axis of the first contact, wherein the first contact is connected to the second contact in a closed position, wherein the first contact is disconnected from the second contact in an open position, wherein the first contact, at an end thereof directed towards and adjacent to the second contact, has a contact tip comprising an ignition tip provided at an inner opening of the first contact defined by the contact tip, and wherein the ignition tip protrudes from a neighbouring, surrounding part of the contact tip in the direction of the longitudinal center axis,
wherein the ignition tip is located between an inner periphery of said end and Ri+⅓(Ro−Ri), wherein Ro is the outer radius of the contact tip at said end and Ri is the inner radius of the contact tip at said end; and
a spindle extending through the first contact and having a longitudinal center axis which coincides with the longitudinal center axis of the first contact, and wherein the inner opening defined by the contact tip is provided for the protrusion of the spindle in connection to a motion of the spindle in relation to the first contact in the direction of the longitudinal center axis of the first contact.

16. A disconnector according to claim 15, wherein the ignition tip is located at a point in an axial direction, wherein the point being geometrically equal to a crest of a contour of the first contact or the point being geometrically not less than the crest of a contour by an average radius of the ignition tip located between an inner periphery of said end and Ri+⅓(Ro−Ri).

17. The disconnector according to claim 15, wherein, in the open position and upon application of a voltage difference between the first contact and the second contact, the ignition tip has a higher field gradient compared to remaining portions of the contact tip.

18. The disconnector according to claim 15, wherein, in the open position and upon application of a voltage difference between the first contact and the second contact, the field gradient at the ignition tip is at least 20% higher as compared to remaining portions of the contact tip.

19. The disconnector according to claim 15, wherein, in the open position and upon application of a voltage difference between the first contact and the second contact, the field gradient at the ignition tip is 30% to 70% higher as compared to remaining portions of the contact tip.

20. The disconnector according to claim 15, wherein the second contact presents a recess in which the ignition tip is received without being in physical contact with the second contact in the closed position of the disconnector.

21. The disconnector according to claim 15, wherein the contact tip of the first contact is rotational symmetric, and wherein a diameter of the rotation is at least larger than an average radius of the ignition tip located between an inner periphery of said end and Ri+⅓(Ro−Ri).

22. The disconnector according to claim 15, wherein the first contact is movably arranged in a direction of the longitudinal center axis, and wherein the second contact is a fixed contact, and wherein in said closed position, the contact tip is connected to the second contact.

23. The disconnector according to claim 15, wherein a thickness of wall of the first contact is at least larger than the average radius of the ignition tip located between an inner periphery of said end and Ri+⅓(Ro−Ri) if the first contact is rotational symmetric, and wherein the average radius of the ignition tip is at least smaller than an average radius of the surrounding part of the contact tip.

24. The disconnector according to claim 15, wherein the average radius of the ignition tip located between an inner periphery of said end and Ri+⅓(Ro−Ri) is at least a threshold times smaller than the average radius of the of the surrounding part of the contact tip in the direction of the longitudinal center axis, wherein the threshold is 5+5 times of surface ratio, and wherein the surface ratio is ratio of rest of the first contact to the ignition tip.

25. The disconnector according to claim 15, comprising an insulating medium between the first contact and the second contact, wherein the insulating medium comprises at least one of Sulphur hexafluoride (SF6), air, Carbon dioxide (CO2), Oxygen (O2), a fluoroketone mixture, and a nitrile mixture.
